(19) United States
(12) Patent Application Publication
(10) Pub. No.: US 2026/0219936 A1
(43) Pub. Date: Jul. 30, 2026

(54) GENERATING AND MANAGING CUSTOMIZED CONTAINER RESOURCE ENVIRONMENTS IN A CLOUD COMPUTING SYSTEM

(71) Applicant: Microsoft Technology Licensing, LLC, Redmond, WA (US)

(72) Inventors: Alexandra JJ DICKERSON, New York, NY (US); Kendal Lamar DOUGLAS, Alexandria, VA (US); Rebecca Jane HALLA, Rye, NH (US); Melissa Marie HALL, Seattle, WA (US); Christopher Michael BITTNER, Arlington, WA (US); Branden Ichiro TANGA, Redwood City, CA (US); Robert Forrest WILCOX, Leander, TX (US); Xingyi ZHANG, Kirkland, WA (US); David Michael ASHLEY, Sumner, WA (US); Peter James KAY, II, McKinney, TX (US)

(21) Appl. No.: 19/040,621

(22) Filed: Jan. 29, 2025

(51) Int. Cl. G06F 9/50

(52) U.S. Cl. CPC G06F 9/5027

(57) ABSTRACT

This disclosure describes configuring and deploying virtual desktop environments based on preconfigured, customized resource container environments (called stamps). In particular, this disclosure describes a cloud stamp system that facilitates quickly and efficiently developing and implementing virtualization at a large scale while allowing for personalization. In various implementations, the cloud stamp system streamlines the engineering process for creating, deploying, and maintaining virtual desktop infrastructure at scale by utilizing preconfigured cloud resources customized at deployment based on configuration settings. Among the benefits of improved computing efficiency, the cloud stamp system provides significant security improvements by enforcing security measures and policies at every level.

### BACKGROUND

In recent years, advancements in both hardware and software have significantly transformed cloud computing environments, enabling virtual environments that provide scalable resources and services. However, creating and deploying virtual desktop environments presents several technical challenges, particularly in terms of security. For example, many current virtual desktop deployment systems are prone to introducing errors that can compromise the security and stability of the virtual environments. In various implementations, some systems require engineers to manually launch virtual machines and virtual desktops, often resulting in inadvertently introduced vulnerabilities. By not fully implementing proper security policies at every step and resource, these existing systems and processes can introduce significant security risks, such as misconfigurations or oversights that expose sensitive data or violate best practices. Additionally, many current systems use processes that take several days to weeks to implement a virtual desktop environment, tying up computing resources. These challenges highlight the need for improved approaches to ensure high levels of security, accuracy, and efficiency in deploying virtual desktop environments.

### BRIEF DESCRIPTION OF THE DRAWINGS

The following detailed description provides example implementations accompanied by drawings. Additionally, each of the figures listed below corresponds to one or more implementations discussed in this disclosure.

FIG. 1 illustrates an example overview of implementing the cloud stamp system to automatically generate and maintain a customized resource container environment (“stamp”) in a cloud computing system.

FIG. 2 illustrates an example computing environment of a cloud computing system where the cloud stamp system is implemented.

FIGS. 3A-3B illustrate an example block diagram of a customized resource container environment (“stamp”).

FIGS. 4A-4C illustrate example flows of the cloud stamp system creating a customized resource container environment (“stamp”) in a cloud computing system.

FIG. 5 illustrates an example diagram of an application that displays multiple implemented virtual desktop environments in a cloud computing system.

FIG. 6 illustrates an example diagram of maintaining a customized resource container environment in a cloud computing system.

FIG. 7 illustrates an example series of acts of computer-implemented methods for creating one or more customized resource environments in a cloud computing system.

FIG. 8 illustrates example components included within a computer system that implements the cloud stamp system.

### DETAILED DESCRIPTION

This disclosure describes configuring and deploying virtual desktop environments based on preconfigured, customized resource container environments (called “stamps”). In particular, this disclosure describes a cloud stamp system that facilitates the quick and efficient development and implementation of virtualization at a large scale while allowing for personalization. In various implementations, the cloud stamp system streamlines the engineering process for creating, deploying, and maintaining virtual desktop infrastructure at scale by utilizing preconfigured cloud resources customized at deployment based on configuration settings. Among the benefits of improved computing efficiency, the cloud stamp system provides significant security improvements by enforcing security measures and policies at every level.

Accordingly, implementations of the present disclosure provide benefits and solve problems in the art with systems, computer-readable media, and computer-implemented methods that utilize a cloud stamp system to improve the efficiency, accuracy, and security of deploying customized resource container environments “stamps.” As described below, the cloud computing system automatically sets up, configures, and connects various services and data resources in a cloud resource group to ensure efficient and accurate deployment. The cloud stamp system also implements system-wide and individualized role-based access controls (RBACs) to prevent unauthorized access while ensuring that authorized users have access to the resources they need.

To elaborate, consider this example of the cloud stamp system creating one or more customized resource environments in a cloud computing system. Upon receiving a resource environment creation request to generate a customized resource environment of a specific type in the cloud computing system, the cloud stamp system identifies preconfigured environment data associated with a customizable resource environment (“stamp”) of the specific type. In addition, the cloud stamp system receives a set of configuration inputs for the customizable resource environment of the specific type. In response, the cloud stamp system can create a cloud resource group within the cloud computing system that will act as a cloud resource container for the data resources indicated in the preconfigured environment data. For instance, the cloud stamp system generates configuration functions for the data resources based on the set of configuration inputs and configures role-based access control roles (RBACs) for the data resources. Furthermore, the cloud stamp system provisions one or more virtual machines within the cloud resource group based on the configuration functions and the set of configuration inputs to generate the customized resource environment.

As mentioned above, some cloud computing systems can provide virtual desktop services. For example, a cloud-based virtual desktop service utilizes a set of virtual machines (VMs) and data resources in the cloud to provide requested features and functionality to users. In various implementations, one or more users connect to a virtual desktop to gain access to their requested services. However, as previously mentioned, creating, implementing, provisioning, and maintaining cloud-based virtual desktop services can be an arduous manual process that requires coordination among several cloud resources and network services. Typically, starting up a new virtual desktop environment can take between 10 days and three weeks to manually configure and deploy, which prevents deployment from occurring on a large scale.

Additionally, due to the numerous steps involved and the complex connections between resources and services, misconfigurations and oversights can introduce vulnerabilities when setting up a virtual desktop environment. Similarly, improper security configurations can lead to technical issues, ranging from inadequate security to inadvertent blocking of access to services.

As described in this disclosure, the cloud stamp system provides several significant technical benefits in terms of improved computing security and efficiency compared to existing systems. Moreover, the cloud stamp system provides several practical applications that address problems related to creating, configuring, deploying, and maintaining virtual desktop environments that include customized resource environments or stamps in a cloud computing system.

In contrast to existing systems, the cloud stamp system provides an efficient avenue to create containerized resource environments that are secure and scalable. For example, the cloud stamp system provides preconfigured environment data along with configuration data to automate the process of generating a customizable resource environment (or stamp) in a cloud computing system. In various implementations, the preconfigured environment data enables the efficient creation of a stamp by forming or creating cloud resource groups, adding data resources, generating configuration functions, applying security policies, and provisioning virtual machines. In some instances, the preconfigured environment data enables additional functions to launch a virtual desktop environment.

In particular, the cloud stamp system ensures that security is enforced at every step of the process and every configuration level. Furthermore, in many instances, the cloud stamp system ensures that maximum security policies (e.g., least permissive permissions) that still allow authorized user access are applied to resources. For example, the cloud stamp system configures and applies RBAC roles for some or all data resources implemented in a stamp. By doing so, the cloud computing system prevents unintended vulnerabilities from being introduced due to not fully implementing proper security policies at every step and for every resource.

In various implementations, the cloud stamp system increases efficiency by standardizing the deployment of virtual desktops, which allows customizable resource environments to grow at scale. The cloud stamp system also increases computational accuracy by significantly reducing the error rate for launched stamps and virtual desktop environments by using automated and semi-automated standardized processes (while still allowing for customization via configuration inputs). In some instances, the cloud stamp system also provides central management, which allows virtual machines to be managed in a common location, resulting in fewer computational resources.

Additionally, the cloud stamp system manages stamps after deployment. For example, the cloud stamp system monitors and maintains a stamp throughout its lifecycle. Furthermore, the cloud stamp system implements updates and security patches as needed to ensure that a stamp is protected against threats. The cloud stamp system may perform updates automatically or through a simple interface selection.

Indeed, the cloud stamp system provides improvements in efficiency, accuracy, and flexibility, which allow for improved operation, management, and scalability. For instance, virtual desktop environments can be created and maintained at a high level while still ensuring their accuracy, top-level security, and resource efficiency. Furthermore, deployment can now be completed in about an hour by the cloud stamp system, whereas it previously took multiple weeks due to the need to configure several manual connections and perform significant error checking to ensure proper connections.

In various implementations, the cloud stamp system offers additional technical benefits that significantly enhance operational efficiency and security. For example, in various implementations, the cloud stamp system performs rapid patching at scale, ensuring that all virtual machines (VMs) are updated quickly and consistently. In one or more implementations, the cloud stamp system also improves business continuity and disaster recovery (BCDR) capabilities by providing robust mechanisms to ensure data integrity and availability during unforeseen events. In some instances, the cloud stamp system provides standardization across a cloud computing environment or system, leadings to better monitoring and observability, as well as allowing for more accurate and timely alerts. In various implementations, researchers have found that implementations of the cloud stamp system, as described herein, reduce the fleet deployment error rate to just 3% per 200 VMs. Additionally, in various instances, the cloud stamp system enables increased patching frequency by supporting static code analysis, quick deployments to any region, and secure fleet deployment.

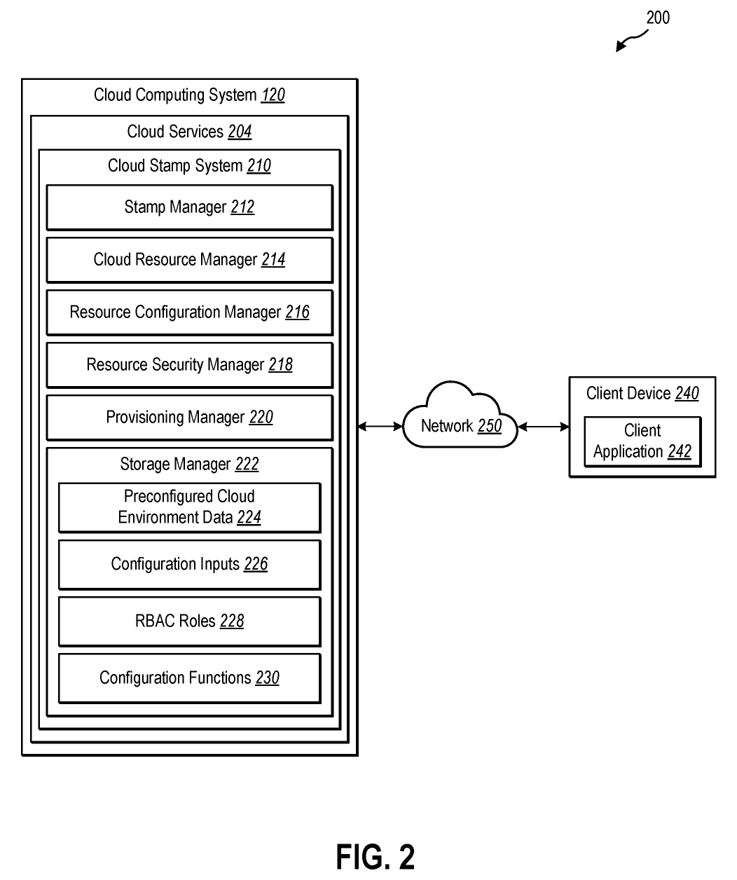

As illustrated in the foregoing discussion, this disclosure utilizes a variety of terms to describe the features and advantages of the cloud stamp system. To clarify, this disclosure describes the cloud stamp system in the context of a cloud computing environment or system. As an example, the term “cloud computing system” refers to a network of interconnected computing devices that provide various services and applications to computing devices (e.g., server devices and client devices) inside or outside of the cloud computing system. An example of a cloud computing system is described below in connection with FIG. 2.

In addition, the term “customizable resource environment” (or stamp) refers to a preconfigured environment with containerized resources that can be customized via configuration inputs. A customizable resource environment can be implemented and maintained by a customizable resource environment management system, such as the cloud stamp system. A customizable resource environment can provide a standardized approach for automatically implementing a series of steps to spin up, provision, and finalize virtual machines within a virtual desktop environment to provide specific features and functions. Additional detail about a customizable resource environment or stamp is provided below.

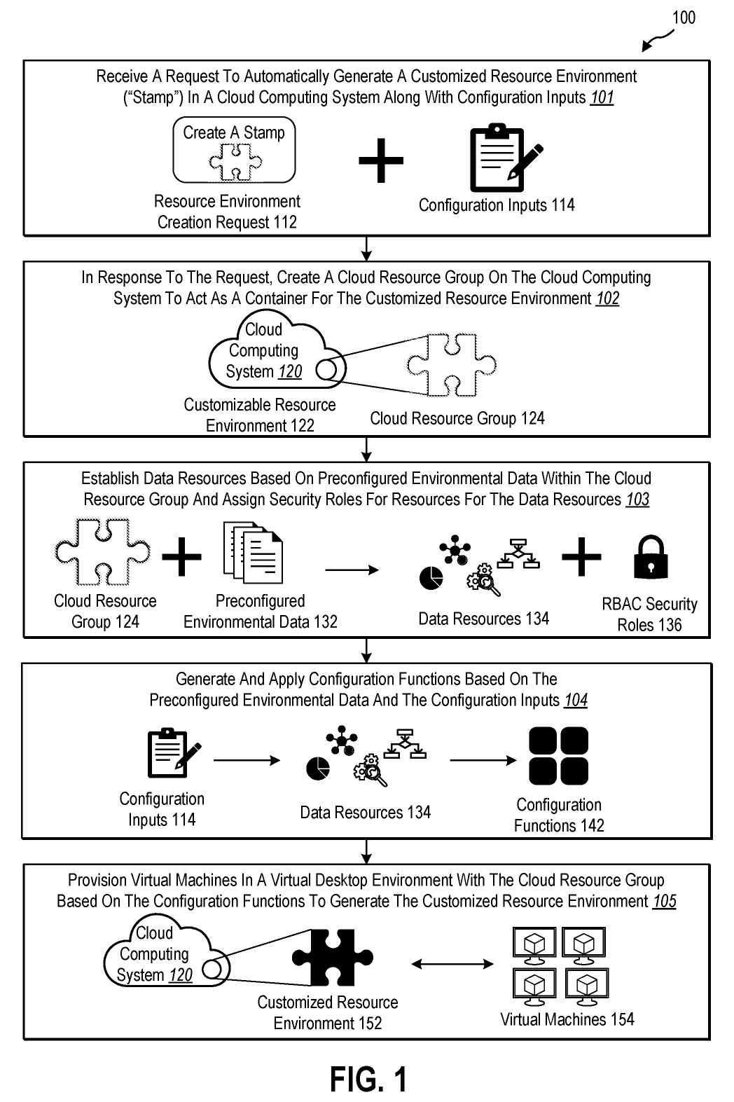

Additional example implementations, definitions, and details of the cloud stamp system are discussed in connection with the accompanying figures, which are described next. For instance, FIG. 1 illustrates an example overview of implementing the cloud stamp system to automatically generate and maintain a customized resource container environment (“stamp”) in the cloud computing system according to some implementations. FIG. 1 includes a series of acts 100 performed by the cloud stamp system within a cloud computing system. While the series of acts 100 provides a high-level overview of the cloud stamp system, additional details are provided in connection with subsequent figures.

As shown, the series of acts 100 includes act 101 of receiving a request to automatically generate a customized resource environment (“stamp”) in a cloud computing system along with configuration inputs. In various implementations, the cloud stamp system receives a resource environment creation request 112 via one of multiple user input streams. The resource environment creation request 112 may request a stamp (i.e., a customizable resource environment) of a specific type (e.g., having a particular set of features and/or offering a specific set of services) to be created and added to the user’s tenant in the cloud computing system 120.

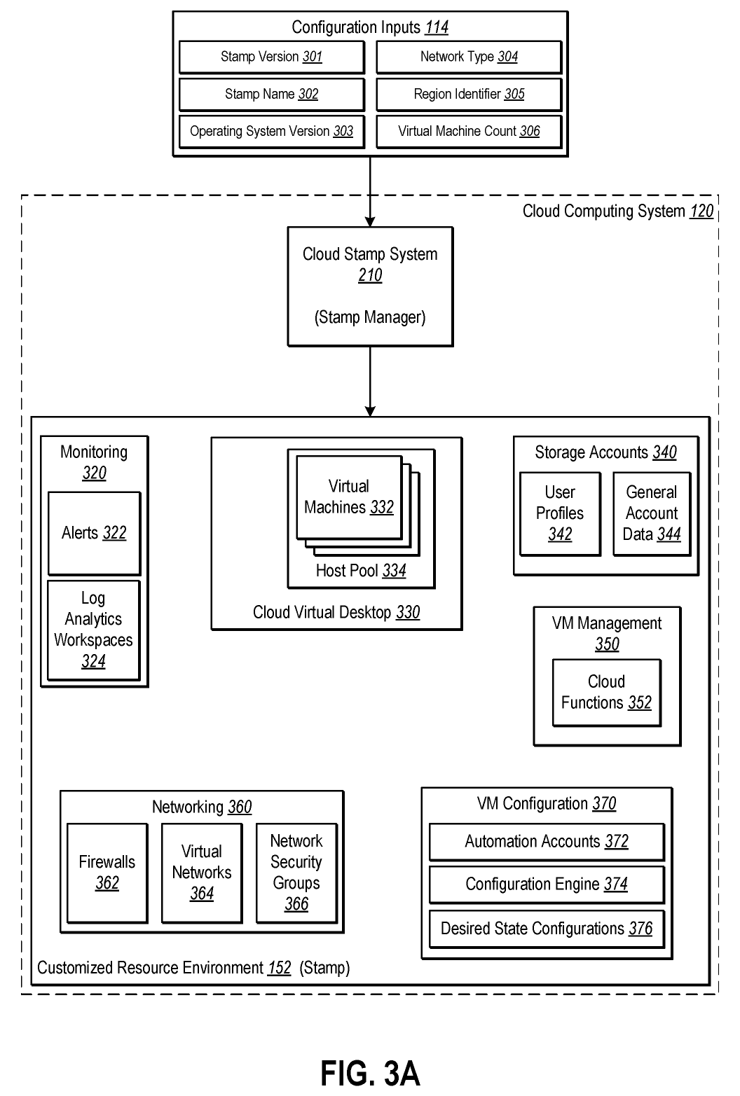

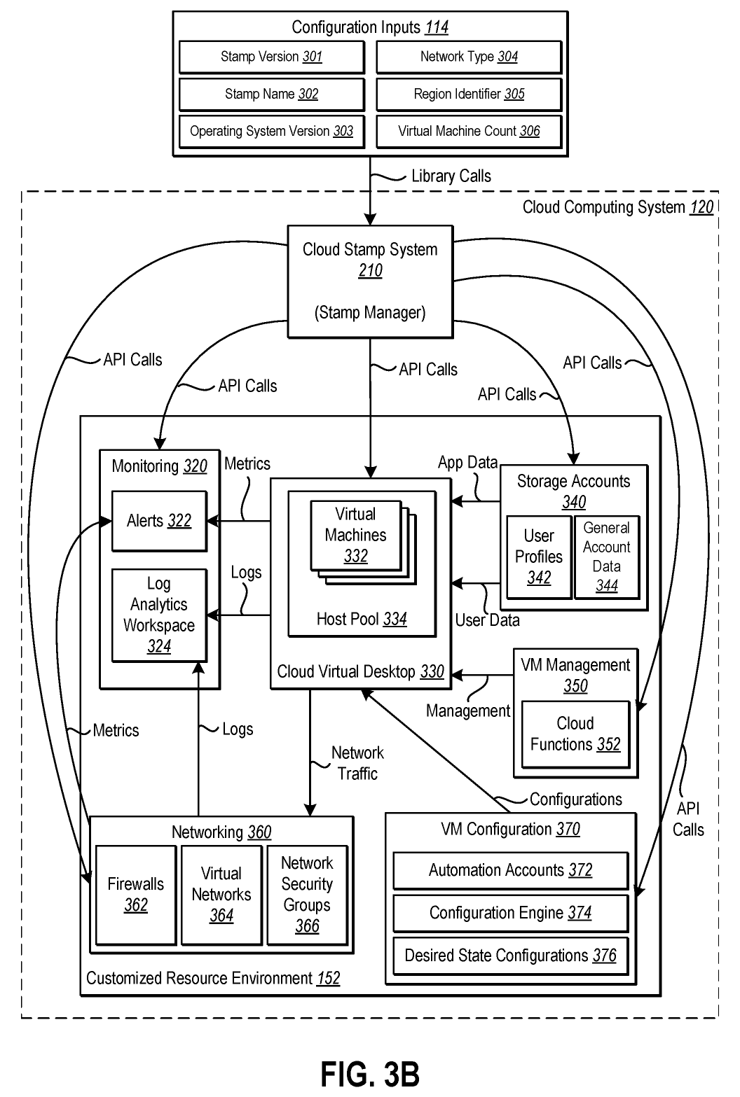

Additionally, as part of receiving the resource environment creation request 112 to create a stamp, the cloud stamp system may prompt for and/or otherwise receive configuration inputs 114 for the request. For example, the user provides a set of stamp-based configuration customizations to be applied to the stamp being created. Additional details about resource environment creation requests and configuration inputs for a stamp are provided in connection with FIGS. 3A-3B.

Act 102 includes creating, in response to the request, a cloud resource group on the cloud computing system to act as a container for the customizable resource environment. In various implementations, the cloud stamp system responds to a request to create the stamp (i.e., customizable resource environment 122) by initiating the stamp creation process. The stamp creation process can follow a stamp creation workflow based on preconfigured environment data associated with a stamp, modified by the configuration inputs 114, to create the stamp.

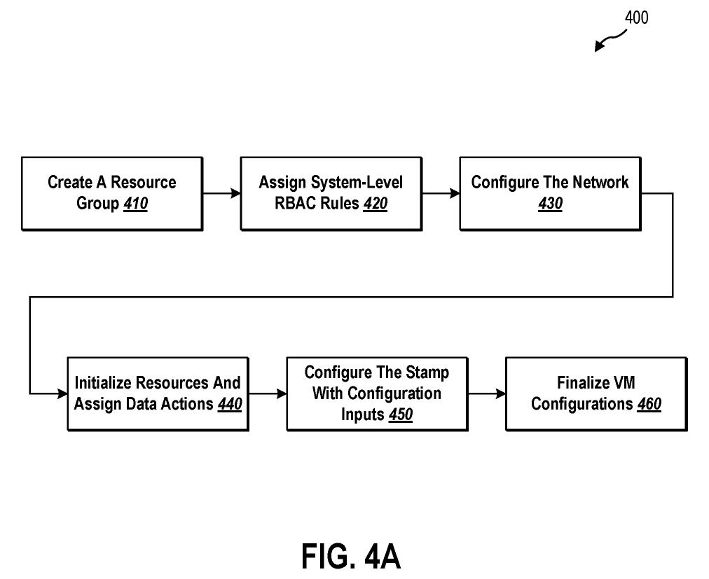

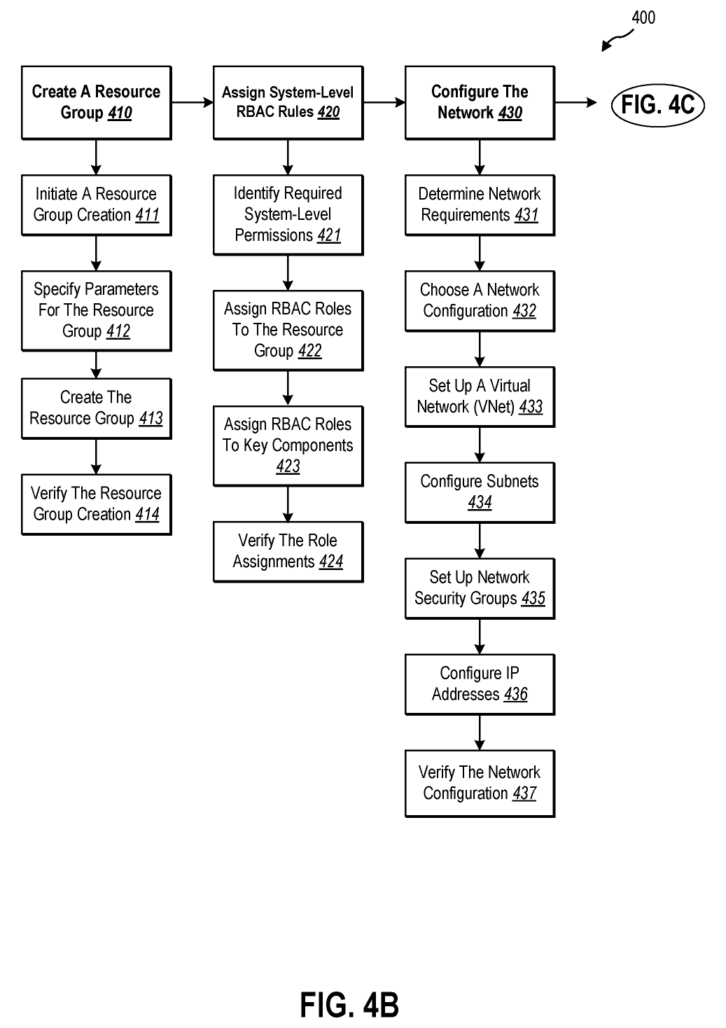

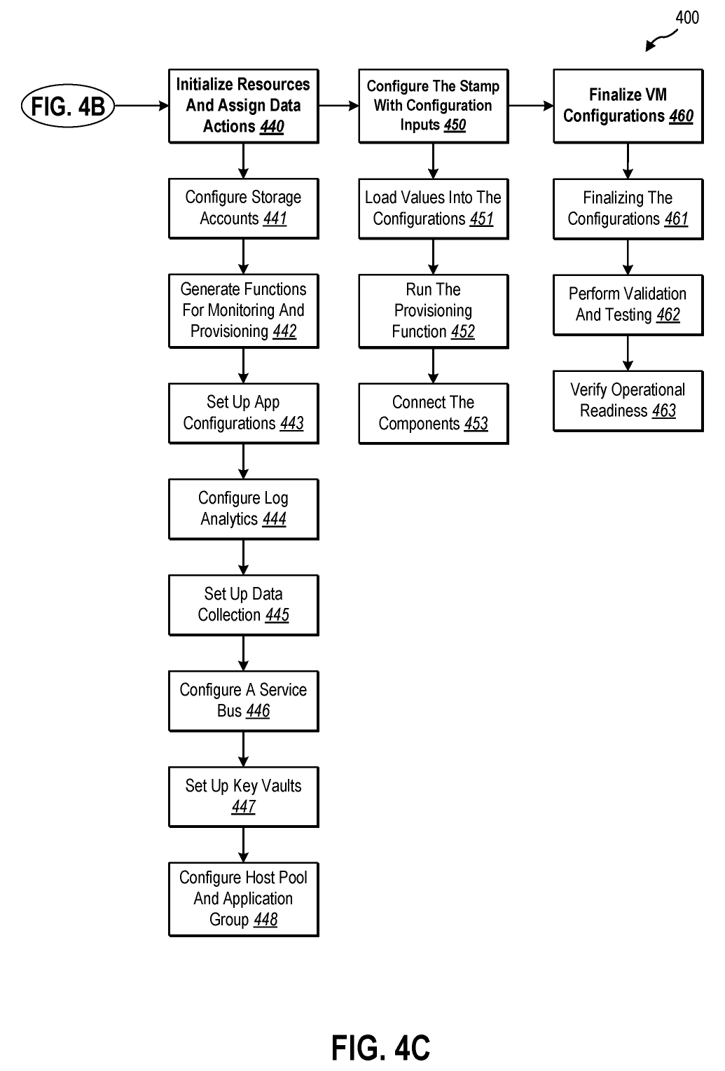

As an initial step in the stamp creation workflow, the cloud stamp system generates an organizational structure on the cloud computing system for containing the data resources of the group. In particular, the cloud stamp system creates a cloud resource group 124. The cloud resource group 124 acts as a cloud resource container for data resources associated with the stamp. Additional details about setting up a cloud resource group are provided below in connection with FIGS. 3A-3B and FIGS. 4A-4B.

Act 103 includes establishing data resources based on preconfigured environment data within the cloud resource group and assigning security roles for the data resources. As mentioned previously, in various implementations, the cloud stamp system uses preconfigured environment data 132 to implement the stamp creation workflow. For example, the preconfigured environment data 132 may cause the cloud stamp system to establish and/or initialize data resources 134 in the cloud resource group 124. Furthermore, the preconfigured environment data 132 may provide direction for implementing RBAC security roles 136 for the cloud resource group 124 and/or the data resources 134 (individually and/or collectively). Additional details about establishing data resources and applying security policies are provided below in connection with FIGS. 4A and 4C.

Act 104 includes generating and applying configuration functions based on the preconfigured environment data and the configuration inputs. In various implementations, the cloud stamp system generates sets of configurations for the data resources 134, referred to as configuration functions 142, to ensure the resources operate as indented. In one or more implementations, the cloud stamp system uses the preconfigured environment data 132 to generate the configuration functions 142. Additionally, the cloud stamp system uses the configuration inputs 114 to modify the configuration functions 142 to apply customized settings when implemented on the data resources 134.

Furthermore, the cloud stamp system can apply the configuration functions 142 to the data resources 134. For example, upon completing the setup of the cloud resource group 124 and various resources within the group, as well as generating configuration functions 142 customized based on configuration inputs 114, the cloud stamp system applies the configuration functions 142 to the data resources 134. Additional details about generating and applying configuration functions to various cloud resources are provided below in connection with FIGS. 4A and 4C.

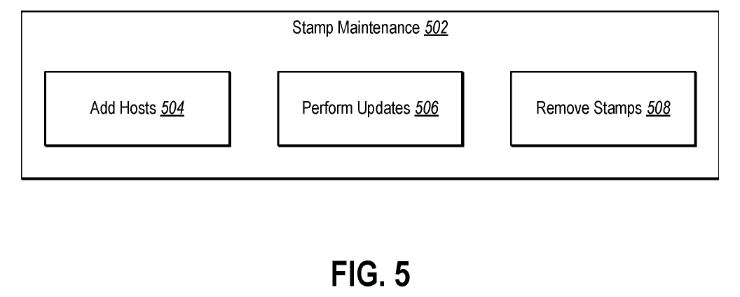

Act 105 includes provisioning virtual machines in a virtual desktop environment within the cloud resource group based on the configuration functions to generate the customizable resource environment. For instance, the cloud stamp system ensures that configuration data resources are connected to necessary elements and then uses the configured resources to provision virtual machines 154 within the customizable resource environment 152 (e.g., stamp). In some instances, the cloud stamp system also finalizes any virtual machine configurations and/or loads any missing applications and services onto the virtual machines to ensure the stamp provides the requested services. Additional details about finalizing stamp creation are provided below in connection with FIGS. 4A, 4C, and 5.

With a stamp implemented, one or more users of a tenant can access and utilize the provided services and features while accurately maintaining high levels of security. Indeed, the cloud stamp system enables a new stamp to be automatically created, with customized settings and enhanced security, in a short time (e.g., approximately one hour). Similarly, due to the efficiency gains from the cloud stamp system performing a streamlined stamp creation workflow, the cloud stamp system can efficiently and accurately scale to create a large number of stamps.

Additionally, in some instances, the cloud stamp system provides a centralized user interface to create, update, remove, and otherwise manage stamps on a user’s tenant in the cloud computing system, which allows for improved management of multiple stamps implemented across a tenant. Furthermore, in various implementations, the cloud stamp system manages stamps throughout their lifecycles. For example, the cloud stamp system ensures that stamps are updated with current service versions, security policies, and safeguards.

With a general overview in place, additional details are provided regarding the components, features, and elements of the cloud stamp system. In particular, FIG. 2 illustrates an example computing environment where the cloud stamp system is implemented in a cloud computing system according to some implementations. Later figures provide examples of various functions performed by the cloud stamp system.

As shown in FIG. 2, the cloud stamp system 210 operates within a computing environment 200 that includes a cloud computing system 120. The cloud computing system 120 includes various systems, including the cloud stamp system 210. In some instances, the cloud computing system 120 represents a MICROSOFT AZURE® cloud computing system. While FIG. 2 shows example arrangements and configurations of devices and systems, other arrangements and configurations are possible.

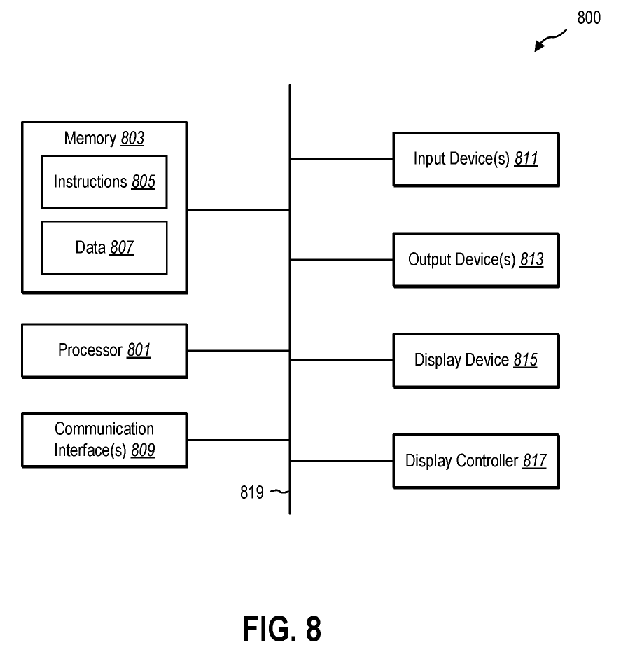

As shown, the computing environment 200 includes a cloud computing system 120, which implements the cloud stamp system 210, and a client device 240 connected via a network 250. Many of these components may be implemented on one or more computing devices, such as one or more server devices. Some of these components may be implemented on personal devices. Further details regarding computing devices are provided below in connection with FIG. 8, along with additional details regarding networks, such as the network 250 shown.

As shown, the cloud computing system 120 includes cloud services 204. In various implementations, the cloud services 204 represent the cloud infrastructure environment or production environment of the cloud computing system 120, which provides products and services for clients, end users, and/or systems. The cloud services 204 include cloud resources, which can include code-based infrastructure (e.g., IaC) resources. The cloud services may represent portions of the cloud computing system 120 that facilitate tenants, resource groups, subscriptions, and other components of a production environment.

In various implementations, the cloud services 204 manage cloud security and security policies. In particular, the cloud services 204 provide a cloud security system that manages various security aspects of the cloud computing system 120. For example, the cloud security system of the cloud services 204 manages identity and access management, data encryption, intrusion detection and prevention, firewalls, security information and event management, security audits, disaster recovery, access control, and authorization, among others.

As shown in FIG. 2, the cloud services 204 include the cloud stamp system 210. In some implementations, the cloud stamp system 210 is located on a separate computing device within the cloud computing system 120, separate from the cloud services 204. In some instances, the cloud stamp system 210 is located separately from the cloud computing system 120.

As mentioned earlier, the cloud stamp system 210 provides a framework for creating, deploying, updating, and maintaining stamps (i.e., customizable resource environments) in a cloud infrastructure environment, such as a tenant domain of the cloud computing system 120. As shown, the cloud stamp system 210 includes various components and elements implemented in hardware and/or software. For example, the cloud stamp system 210 includes a stamp manager 212, a cloud resource manager 214, a resource configuration manager 216, a resource security manager 218, a provisioning manager 220, and a storage manager 222. The storage manager 222 includes preconfigured cloud environment data 224, configuration inputs 226, RBAC roles 228, configuration functions 230, and other data stored by the cloud stamp system 210.

In various implementations, the stamp manager 212 facilitates management functions for stamps. For example, the stamp manager 212 facilitates receiving stamp creation requests (i.e., resource environment creation requests), determining which preconfigured cloud environment data to use based on the requested stamp, updating stamps, and removing stamps, among other functions.

In one or more implementations, the cloud resource manager 214 facilitates the creation and deployment of cloud data resources. For example, in some instances, the cloud resource manager 214 creates a cloud resource group and establishes data resources. In some implementations, the resource configuration manager 216 manages the configuration of resources, such as generating configuration functions 230 based on configuration inputs 226.

In some implementations, the resource security manager 218 manages the security of a stamp during its creation and lifespan. For example, the resource security manager 218 determines and applies RBAC roles 228 to multiple elements and/or to each level of a stamp, such as by applying strict access controls to ensure that high-level security policies are maintained. In one or more implementations, the provisioning manager 220 manages the provisioning and finalization of components and virtual machines within a stamp.

The components and managers included in FIG. 2 are provided for example purposes to illustrate the features and functions of the cloud stamp system 210. Indeed, the cloud stamp system 210 may utilize additional or different managers or components to perform the actions described in this document. Accordingly, the remainder of the document will be described in terms of the cloud stamp system 210 performing various functions and actions to generate and maintain a stamp in a cloud computing system.

As shown, the computing environment 200 includes the client device 240. In various implementations, the client device 240 is associated with a user (e.g., a user client device) or system, such as a user who is requesting a stamp of a specific type from and/or providing configuration inputs 226 to the cloud stamp system 210. In some implementations, the client device 240 includes a client application 242, such as a web browser, mobile application, or another form of computer application for accessing and/or interacting with the cloud computing system 120 and/or the cloud stamp system 210.

FIGS. 3A-3B provide a schematic illustration of the components of a stamp. To illustrate, FIGS. 3A-3B illustrate an example block diagram of a customized resource container environment (“stamp”) according to some implementations. In particular, FIG. 3A introduces the various components and elements, while FIG. 3B shows the interactions between the components and elements. FIGS. 3A-3B include the cloud stamp system 210 and a customizable resource environment 152 within the cloud computing system 120. In some instances, the cloud stamp system 210 is referred to as a stamp manager. Likewise, in some implementations, the customizable resource environment 152 is referred to as a stamp.

FIG. 3A includes the configuration inputs 114 and the cloud computing system 120, along with the cloud stamp system 210 introduced above. The configuration inputs 114 include various inputs for customizing a stamp. As shown, the configuration inputs 114 can include a stamp version 301, a stamp name 302, an operating system version 303, a network type 304, a region identifier 305, and/or a virtual machine count 306. In various implementations, the cloud stamp system 210 receives one or more of the configuration inputs 114 in connection with a stamp creation request.

In various implementations, the stamp version 301 corresponds to a particular stamp type being created. For example, the stamp type may align with the services and/or features to be provided by a virtual desktop environment. Stamp types can range from development stamps to data processing mapping stamps. In various implementations, the stamp version 301 may represent a virtual machine (VM) version or type. For instance, the stamp version 301 is a VM stock-keeping unit (SKU) corresponding to a specific VM type, which provides a particular set of features, functions, and/or services.

In some implementations, the stamp name 302 (or customized resource environment name) refers to a naming convention for the stamp. The operating system version 303 (OS version) may indicate which OS type and version to implement on one or more VMs within the stamp being created. The network type 304 may refer to network configuration details for the stamp, and the region identifier 305 may refer to a specific geographic region from which the cloud resources are to be drawn. When present, the virtual machine count 306 (VM count) refers to the number of VMs included in the stamp being created. The configuration inputs 114 may include additional or different parameters. Furthermore, the details associated with each input type provided above may include additional and/or different aspects.

The cloud stamp system 210 can receive the configuration inputs 114 through multiple input approaches. In various implementations, the cloud stamp system 210 receives input from a cloud system engineer who needs to create a new set of virtual machines in a virtual desktop environment for a tenant. In some implementations, the cloud stamp system 210 enables other users to request the creation and/or management of stamps within virtual desktop environments.

In some implementations, the cloud stamp system 210 may provide a graphical user interface to enable users to create new stamps and manage existing stamps. For example, the cloud stamp system 210 provides a virtualization operations center (VOC) for managing stamps on within a tenant. In some implementations, the VOC includes a stamp creation selectable element, input fields for receiving the configuration inputs 114, and/or additional elements for stamp management.

In some implementations, the cloud stamp system 210 allows the configuration inputs 114 to be received through a text interface, such as a command-line interface (CLI). In various implementations, the cloud stamp system 210 receives the configuration inputs 114 via a cloud developer operations pipeline. The cloud stamp system 210 may also receive the configuration inputs 114 and/or stamp creation requests through other input channels.

As shown in FIG. 3A, the cloud computing system 120 includes the customizable resource environment 152. The customizable resource environment 152 provides an example representation of included elements, components, resources, and functions. For example, the customizable resource environment 152 includes cloud resources for monitoring 320, networking 360, VM configurations 370, VM management 350, storage accounts 340, and a cloud virtual desktop 330.

The cloud resources for monitoring 320 include alerts 322 and log analytics workspaces 324 (e.g., an analytics log). The cloud resources for storage accounts 340 include user profiles 342 and general account data 344. The cloud resources for VM management 350 include cloud functions 352. The cloud resources for networking 360 include firewalls 362, virtual networks 364, and network security groups 366 (NSGs). The cloud resources for VM configurations 370 include automation accounts 372, a configuration engine 374, and desired state configurations 376. Additionally, the cloud resources for the cloud virtual desktop 330 include one or more virtual machines 332 (within a host pool 334). In various implementations, these cloud resources work together to configure, provision, and implement the one or more virtual machines 332 within the cloud virtual desktop 330. While illustrative, each of these cloud resources can include additional and/or different elements, functions, and/or components.

FIG. 3B adds communications between the cloud stamp system 210 and the customizable resource environment 152. In particular, FIG. 3B includes calls (e.g., API calls) from the cloud stamp system 210 to the cloud resources in the customizable resource environment 152, for example, to establish the cloud resources based on stamp preconfigured environment data.

In addition, the customizable resource environment 152 shows reporting calls (e.g., logs, metrics, traffic), configuration calls, and data among the cloud resources and between the resources and the cloud virtual desktop 330. For example, the cloud stamp system 210 creates configuration functions for one or more resources based on preconfigured environment data and the configuration inputs 114. The resources use the configuration functions to configure the one or more virtual machines 332 within the cloud virtual desktop 330. Additional details about setting up and utilizing cloud resources within the customizable resource environment 152 are provided in connection with FIGS. 4A-4C.

Turning now to FIGS. 4A-4C, additional details are provided regarding setting up a cloud resource group, establishing data resources and applying security policies, generating and applying configuration functions to various cloud resources, and finalizing stamp creation. In particular, FIGS. 4A–4C illustrate example flows of the cloud stamp system creating a customized resource container environment (“stamp”) in a cloud computing system according to some implementations.

As shown, FIGS. 4A-4C include a series of acts 400 performed by the cloud stamp system 210. In particular, FIG. 4A introduces acts in the series of acts 400. FIG. 4B and FIG. 4C elaborate on each act while describing corresponding sub-acts.

At a high level, in response to a stamp creation request to generate a stamp of a particular type and based on customized configuration inputs, the series of acts 400 corresponds to the cloud stamp system 210 creating a resource group, assigning permissions, configuring the network, setting up resources, loading configurations, provisioning VMs, and finalizing the configuration based on the preconfigured environment data and configuration inputs.

To elaborate, the series of acts 400 includes act 410 of creating a resource group. In various implementations, a cloud resource group is a logical group or container for resources that will be part of the stamp. Act 420 includes assigning system-level RBAC rules. For example, the cloud stamp system 210 assigns system-level permissions to the stamp itself to organize the structure of the stamp.

Act 430 includes configuring the network. For example, the cloud stamp system 210 sets up the network infrastructure that the stamp will use, including whether to create a new managed network or to use a create a new network. Act 440 includes initializing resources and assigning data actions. In some instances, this act includes the cloud stamp system 210 setting up and configuring the data resources the stamp will need to operate and connecting the resources together.

Act 450 includes configuring the stamp with configuration inputs. For instance, the cloud stamp system 210 loads specific values into the data resources set up in previous steps. As shown, act 460 includes finalizing VM configurations. In various implementations, act 460 includes the cloud stamp system 210 provisioning, implementing, and verifying to ensure that the VMs are fully operational. Each act will be described in greater detail next.

To elaborate, FIG. 4B includes additional details about act 410, act 420, and act 430. As mentioned above, act 410 includes creating a resource group. In various implementations, the cloud stamp system 210 creates a cloud resource group, which acts as a container for cloud resources that will be part of the stamp. These resources can include VMs, storage accounts, network interfaces, and other assets or resources.

In various implementations, the cloud resource group aids in organizing and managing resources as a single entity within the cloud computing system. In some implementations, the cloud resource group allows resources within the group to share the same lifecycle, making deployment, updating, and deletion more efficient to manage. In one or more implementations, the cloud resource group allows RBAC roles to be efficiently and accurately applied at the resource group level to manage permissions for the resources within the group.

As shown, act 410 includes various sub-acts, such as sub-act 411 of initiating a resource group creation. In various implementations, the cloud stamp system 210 uses cloud portals, CLI, and API calls to initiate the creation of a resource group (e.g., receiving a request for resource environment creation). For example, the cloud stamp system 210 begins to spin up a stamp by receiving specific configuration inputs, such as a stamp name, region, and VM count. In some instances, sub-act 411 also includes receiving a selection of a particular stamp type to create.

Sub-act 412 includes specifying parameters for the resource group. In various implementations, the cloud stamp system 210 defines the parameters for the resource group based on a set of preconfigured environment data associated with the selected stamp type. For example, the name indicates a unique name to be assigned to the cloud resource group and/or stamp, and the region indicates a geographic region or area where the cloud resource group will be located. In some instances, this influences the data center and/or cloud computing system from which the resources within the group will be deployed.

Sub-act 413 includes creating the resource group. In some implementations, the cloud stamp system 210 executes the command or API call to create the resource group. For instance, once the parameters are specified, the cloud stamp system 210 creates the cloud resource group in the cloud computing system. In some instances, this includes allocating the necessary resources to establish the cloud resource group and/or storing metadata about the resource group (e.g., the stamp’s name, region, and associated subscription data).

Sub-act 414 includes verifying the resource group creation. In various implementations, the cloud stamp system 210 confirms that the cloud resource group has been successfully created. Indeed, the cloud stamp system 210 can verify that the cloud resource group exists and is ready for use.

Overall, in many implementations, act 410 includes the cloud stamp system 210 creating a cloud resource group to serve as a container for all the resources that will be part of the stamp being created. Act 410 can include specifying parameters, executing the creation command, verifying the creation, and, in some instances, preparing for resource deployment. By doing so, the cloud stamp system 210 implements a cloud resource group that provides a structured way to organize, manage, and secure the resources needed for the stamp.

As mentioned above, act 420 includes assigning system-level RBAC rules. In various implementations, the cloud stamp system 210 assigns permissions to the stamp to allow it to act on itself. By doing so, the cloud stamp system 210 ensures that the necessary permissions are in place for the resources within the stamp to function correctly and for the stamp to manage its own resources.

As shown, act 420 includes sub-act 421 of identifying required system-level permissions. In various implementations, the cloud stamp system 210 determines the necessary permissions for the resource group and its components. For example, the cloud stamp system 210 identifies the roles and permissions needed for the stamp to manage its resources effectively, which may include identifying permissions for creating, modifying, and deleting resources within the resource group.

Sub-act 422 includes assigning RBAC roles to the resource group. In one or more implementations, the cloud stamp system 210 assigns RBAC roles to the cloud resource group at the system level to define the level of access and control that users and services have over the resources within the group. For example, the cloud stamp system 210 assigns roles such as owner, contributor, or reader to the cloud resource group. By doing so, the cloud stamp system 210 ensures that the roles are assigned at the resource group level, providing permissions to all resources within the group.

Sub-act 423 includes assigning RBAC roles to key components. In some instances, the cloud stamp system 210 assigns RBAC roles for key components within the cloud resource group, which may include roles for critical components such as storage accounts, network interfaces, and virtual networks. Indeed, the cloud stamp system 210 can ensure that each component has the necessary permissions to function correctly.

Sub-act 424 verifies role assignments. For example, the cloud stamp system 210 confirms that the RBAC roles are correctly assigned. The cloud stamp system 210 facilitates various approaches (e.g., portal, CLI, and API calls) to verify that the roles have been assigned as intended. In some instances, sub-act 424 includes performing tests to ensure that the assigned roles provide the necessary access and control without granting excessive permissions.

Indeed, in act 420, the cloud stamp system 210 utilizes RBAC role assignments to allow the stamp to manage its own resources. By doing so, the cloud stamp system 210 ensures that only authorized users and services have access to the resources within the resource group, maintaining security and control while also ensuring that the cloud resource group has the foundational permissions needed to manage its resources effectively and securely.

As mentioned above, act 430 includes configuring the network. In various implementations, act 430 includes creating a network stack or configuring a network stack for the stamp. Specifically, the cloud stamp system 210 sets up the network infrastructure that the stamp will use. For example, the cloud stamp system 210 sets up a new managed network stack or selects an existing network stack.

As shown, act 430 includes various sub-acts, such as sub-act 431 of determining network requirements. For instance, the cloud stamp system 210 identifies network requirements for the stamp by assessing the connection needs of the stamp. For example, the cloud stamp system 210 identifies the number of VMs, expected traffic, security requirements, and connectivity needs.

Sub-act 432 includes choosing a network configuration. In various implementations, the cloud stamp system 210 determines whether to use a managed network stack or an existing network stack. A managed network stack may include a preconfigured network setup provided by the cloud computing system 120, which can simplify the process and promote best practices. An existing network stack can include a pre-established network configuration that can be reused for the stamp.

Sub-act 433 includes setting up a virtual network (VNet). In various implementations, the cloud stamp system 210 creates or configures a VNet, which may vary based on the selected network configuration. For example, when using a managed network stack, the cloud stamp system 210 can create a new VNet with appropriate subnets and address spaces. Conversely, when using an existing network stack, the cloud stamp system 210 may ensure that the VNet is configured to meet the network requirements of the stamp. Sub-act 434 includes configurating subnets. For instance, the cloud stamp system 210 sets up subnets within a VNet by defining subnets to segment the network and organize resources. In addition, the cloud stamp system 210 can define subnet settings such as address ranges, NSGs, and route tables.

Sub-act 435 includes setting up network security groups (NSGs). For example, the cloud stamp system 210 creates and configures NSGs to control inbound and outbound traffic to the VNet and its subnets. The cloud stamp system 210 can also define security rules to allow or deny traffic based on the source, destination, port, and protocol.

Sub-act 436 includes configuring Internet Protocol (IP) addresses. For instance, the cloud stamp system 210 assigns public and private IP addresses to resources. This may include assigning public IP addresses to resources that need to be accessible from the internet and assigning private IP addresses to internal resources for secure communication within the VNet. In some implementations, the cloud stamp system 210 may set up or establish virtual networks (e.g., private virtual networks) for the stamp.

Sub-act 437 includes verifying the network configuration. In various implementations, the cloud stamp system 210 confirms that the network stack is correctly configured. For instance, the cloud stamp system 210 validates the network setup and/or tests the connectivity to ensure resources can communicate properly that security rules are enforced effectively. Additionally, the cloud stamp system 210 can verify that the network infrastructure can scale with the needs of the stamp to accommodate additional resources and traffic as required.

Indeed, act 430 and the corresponding sub-acts include configuring the network stack for the stamp by setting up a VNet, configuring subnets, creating NSGs, assigning IP addresses, and/or setting up private virtual networks if necessary. By doing so, the cloud stamp system 210 creates a network infrastructure that is secure, scalable, and meets the connectivity requirements of the stamp.

As mentioned above, act 440 includes initializing resources and assigning data actions. In various implementations, act 440 includes complete configurations of stamp resources and assigning additional RBAC roles. In many implementations, the cloud stamp system 210 automatically assigns minimal role permissions to data resources when assigning RBAC roles to reduce security risks. Indeed, act 440 focuses on setting up the cloud resources within the stamp, including applying security policies and permissions on an individual resource basis. By doing so, the cloud stamp system 210 ensures proper access and functionality of the needed resources, as the well as correct permissions needed to operate.

As shown, act 440 includes various sub-acts, such as sub-act 441 of configuration storage accounts. For example, the cloud stamp system 210 creates storage accounts to be used by the stamp for storing data. In some implementations, sub-act 441 includes assigning RBAC roles to the storage accounts to ensure that only authorized users and services can access them. Additionally, sub-act 441 includes configuring the profile storage. For example, the cloud stamp system 210 sets up storage specifically for user profiles and assigns RBAC roles to manage access to these profiles, which ensures that user data is secure and accessible only to authorized entities.

Sub-act 442 includes generating functions for monitoring and provisioning. In various implementations, the cloud stamp system 210 provides functions for stamp monitoring and VM provisioning by setting up functions that will monitor the stamp’s performance and provision VMs as needed. For example, the cloud stamp system 210 sets up a provisioning function that creates the infrastructure and components needed to provision VMs for the stamp. Additionally, the cloud stamp system 210 can configure the necessary settings and permissions (e.g., RBAC roles) and assign the RBAC roles that will allow the provisioning function to operate correctly.

Sub-act 443 includes setting up app configurations. In various implementations, the cloud stamp system 210 sets up application configurations by configuring application settings used by the stamp. In addition, the cloud stamp system 210 can assign RBAC roles that manage access to these configurations. Sub-act 444 includes configuring analytics logs. For example, the cloud stamp system 210 sets up analytics logs workspaces to monitor and analyze the logs generated by the stamp. As with other steps, the cloud stamp system 210 can assign RBAC roles to ensure that only authorized users access and analyze these logs.

Sub-act 445 includes setting up data collection. In some implementations, the cloud stamp system 210 establishes data collection mechanisms by configuring data collection tools to gather performance and usage data from the stamp. The cloud stamp system 210 can also assign RBAC roles to manage access to this data, ensuring that it is secure and accessible only to authorized users. Sub-act 446 includes configuring a service bus, which can include setting up a service bus for messaging and communication between different components of the stamp. As with other sub-acts, the cloud stamp system 210 can assign RBAC roles to manage access to the service bus to ensure secure and efficient communication.

Sub-act 447 includes setting up key vaults. For example, the cloud stamp system 210 sets up a key vault by configuring the key vault to store and manage cryptographic keys and secrets used by the stamp. The cloud stamp system 210 can set up multiple key vaults. Additionally, the cloud stamp system 210 can assign RBAC roles to ensure that only authorized users and services can access the key vaults.

Furthermore, sub-act 448 includes configuring a host pool and application group. In various implementations, the cloud stamp system 210 configures the host pool as a collection of VMs used by the stamp. In various implementations, the number of VMs in the host pool is based on the VM count in the configuration inputs. Additionally, the cloud stamp system 210 can configure the application group to include applications that should be made available to users of the VMs and/or the virtual desktop environment (e.g., application groups include a set of applications to which users will have access). The cloud stamp system 210 can also assign RBAC roles to manage access to the host pool and application group.

As shown, act 440 includes a comprehensive process that involves setting up various resources and assigning the necessary RBAC roles to ensure that the stamp operates securely and efficiently. Indeed, each component, from storage accounts to key vaults, is specifically configured with defined permissions to maintain a high level of security and functionality.

In various implementations, the cloud stamp system 210 performs one or more of the acts or sub-acts in parallel. For example, the cloud stamp system 210 performs the setup of various resources such as networking, storage accounts, monitoring functions, and other components using asynchronous calls. By doing so, the cloud stamp system 210 can initiate multiple tasks simultaneously without waiting for each task to complete before starting the next one. In some implementations, the cloud stamp system 210 waits for one act or sub-act to complete before performing a subsequent action when a certain task requires the completion of another task. For example, when setting up subnets of a VNet, the cloud stamp system 210 needs to wait for the VNet to be set up or established before configuring the subnets within that network.

As mentioned above, act 450 includes configuring the stamp with the configuration inputs. For example, act 450 includes loading specific configuration values into the corresponding data resources. The cloud stamp system 210 loads all the necessary values configured in previous actions into their respective app configurations, key vaults, and alerts. Act 450 may also include running the provisioning function to initially create the VMs, ensuring that the cloud resources are initialized, ready for use, and interacting seamlessly.

In various implementations, act 450 includes loading both user-specific and predefined values. For example, the cloud stamp system 210 loads the configuration functions and/or the configuration inputs into components before launching the components. Additionally, in various implementations, act 450 includes “connecting the wires” by linking or integrating various components and configurations that have been set up in the previous steps.

As shown, act 450 includes various sub-acts, such as sub-act 451 of loading values into the configurations. For example, the cloud stamp system 210 populates app configurations, key vaults, and alerts with the necessary values. In some instances, this includes loading specific settings and parameters into the configurations that were set up in act 440, which may be essential for the proper functioning of the stamp.

Sub-act 452 includes running the provisioning function. In various implementations, the cloud stamp system 210 executes the provisioning function to create the VMs. For instance, the cloud stamp system 210 performs the provisioning function (as configured above) and uses the loaded configurations and values to create the VMs within the host pool of the virtual desktop environment. By executing the provisioning function, the cloud stamp system 210 ensures that the VMs are set up according to the specified parameters.

Sub-act 453 includes connecting the components. In various implementations, the cloud stamp system 210 integrates and links all of the established components (e.g., cloud data and network resources). As mentioned above, the cloud stamp system 210 “connects the wires” of the stamp together and ensures that all the resources and configurations are properly linked. For example, the cloud stamp system 210 ensures that the VMs are connected to the correct network, that the application configurations are correctly applied to the VMs, that the monitoring tools and data collection mechanisms are properly set up and can communicate with the VMs, and/or that the service bus and key vaults are correctly configured and accessible by the VMs. By doing so, the cloud stamp system 210 ensures that all components are correctly linked and can function together as a cohesive unit.

As mentioned above, act 460 includes finalizing VM configurations. In some instances, act 460 includes the configuration engine of the stamp finalizing the stamp setup. For example, once the stamp is created and the VMs are provisioned (act 450), the cloud stamp system 210 utilizes a configuration engine (sometimes referred to as a “config engine”) to complete the detailed configuration of the VMs, which can include setting up the VMs with the necessary applications by applying specific settings, installing software, implementing security policies, and performing validation checks to ensure the VMs are fully operational and ready for use. In some implementations, this includes assigning users to app groups. In some implementations, this includes connecting the app group to the host pool to ensure that users can access the applications when they connect to a VM in the host pool.

As shown, act 460 includes various sub-acts, such as sub-act 461 of finalizing the configuration. In various implementations, the cloud stamp system 210 applies detailed configurations to the VMs to ensure that all specific settings, applications, and policies are applied to the VMs. In some instances, this includes installing necessary software and applications on the VMs, applying security policies and settings to ensure the VMs are secure, and implementing any custom configurations specified by the user or required for requested use cases.

Sub-act 462 includes performing validation and testing. For instance, the cloud stamp system 210 validates the configurations and tests the VMs by performing or conducting validation checks to ensure that all configurations have been applied correctly and that the VMs are functioning as expected. In some instances, this includes ensuring that the VMs can connect to the network and other resources, verifying that the VMs meet performance requirements, and checking that all security settings are correctly applied.

Sub-act 463 includes verifying operational readiness. For example, the cloud stamp system 210 ensures that the VMs are ready for use by confirming that the VMs are fully configured and operational. In some instances, this includes ensuring that users can access the VMs as intended and verifying that all necessary resources (e.g., storage accounts and network connections) are available and properly configured.

As mentioned above, FIG. 5 corresponds to maintaining deployed stamps. In particular, FIG. 5 illustrates an example diagram of an application that displays multiple implemented virtual desktop environments in a cloud computing system according to some implementations. As shown, FIG. 5 includes a component for stamp maintenance 502 that includes adding hosts 504, performing updates 506, and removing stamps 508.

In various implementations, the cloud stamp system 210 performs stamp maintenance 502 by adding hosts to a stamp. For instance, the cloud stamp system 210 identifies the need for additional resources within the existing virtual desktop environment (e.g., due to increased demand or the need for redundancy). Next, the cloud stamp system 210 provisions and configures new VMs to match the existing infrastructure. The cloud stamp system 210 can then integrate the new hosts into the cloud resource group, ensuring they inherit the necessary security roles and configurations.

In some implementations, the cloud stamp system 210 performs stamp maintenance 502 by performing updates 506 on a stamp. In some implementations, stamp updates occur automatically, such as on a regular schedule or when a component or resource update is detected. In some implementations, the cloud stamp system 210 performs an update based on user input. In various implementations, the cloud stamp system 210 uses the configuration engine to apply updates to ensure consistency across all hosts. In some implementations, updates are applied to new hosts when launched.

In some implementations, the cloud stamp system 210 performs stamp maintenance 502 by removing stamps 508 from the virtual desktop environment. For instance, the cloud stamp system 210 identifies when a stamp is no longer needed, either automatically or based on user input. The cloud stamp system 210 may use the removal of a stamp, its components, and resources in a controlled manner to preserve any dependencies or linked resources, if needed. In some implementations, the cloud stamp system 210 uses the configuration engine by reversing the configuration process and ensuring that security roles are appropriately adjusted. Once all resources are safely decommissioned, the cloud stamp system 210 may delete the cloud resource group associated with the stamp.

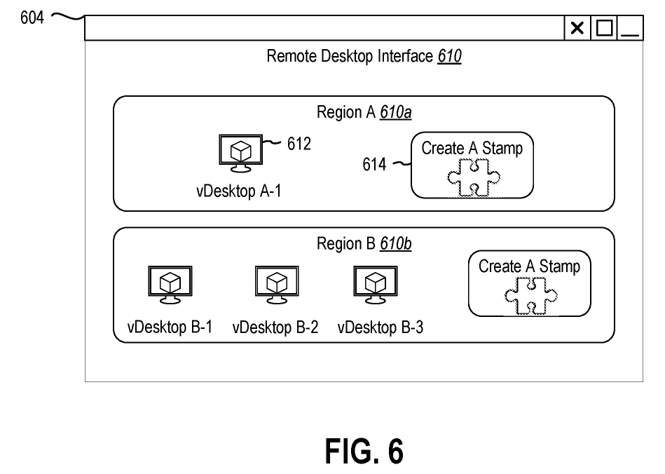

As mentioned above, the cloud stamp system 210 may provide a graphical user interface to enable users to create new stamps and manage existing stamps. To illustrate, FIG. 6 shows an example diagram of maintaining a customized resource container environment in a cloud computing system according to some implementations. In particular, FIG. 6 shows a graphical user interface 604 that may be displayed on a computing device associated with a user and that is in communication with the cloud stamp system 210.

As shown, the graphical user interface 604 includes a remote desktop interface 610. In various implementations, the remote desktop interface 610 is associated with a tenant and displays virtual desktop environments. The remote desktop interface 610 may display additional and/or different components associated with the cloud stamp system 210. Indeed, the remote desktop interface 610 may serve as a central location for stamp management.

As shown, the remote desktop interface 610 displays virtual desktops within different regions. For example, a first region 610a includes a first virtual desktop 612 and a selectable element 614 to generate a new customizable resource environment (e.g., “Create A New Stamp”). Upon selecting the first virtual desktop, the remote desktop interface 610 may be updated to provide stamp management options. The second region 610b shows additional virtual desktops and corresponding selectable elements. Indeed, the remote desktop interface 610 can show any number of regions with their associated virtual desktops and corresponding elements.

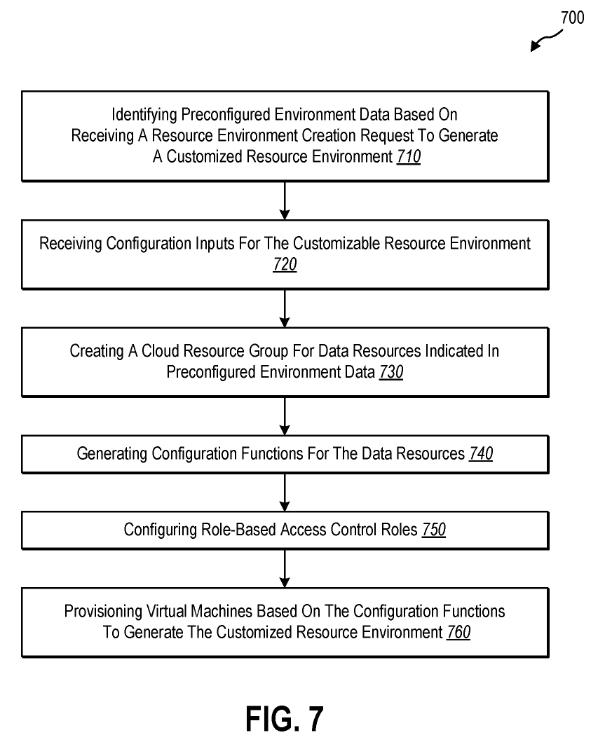

Turning now to FIG. 7, these figures illustrate example series of acts of computer-implemented methods for creating one or more customized resource environments in a cloud computing system according to some implementations. While FIG. 7 illustrate acts according to one or more implementations, alternative implementations may omit, add to, reorder, and/or modify any of the acts shown. In particular, FIG. 7 includes a series of acts 700 performed by the cloud stamp system 210.

The acts in FIG. 7 can be performed as part of a method (e.g., a computer-implemented method). Alternatively, a computer-readable medium can include instructions that, when executed by a processing system with a processor, cause a computing device to perform the acts in FIG. 7. In some implementations, a system (e.g., a processing system comprising a processor) can perform the acts in FIG. 7. For example, the system includes a processing system and a computer memory, which includes instructions that, when executed by the processing system, cause the system to perform various actions or steps.

In FIG. 7, the first series of acts 700 includes act 710 of identifying preconfigured environment data based on receiving a resource environment creation request to generate a customized resource environment. For instance, in example implementations, act 710 involves identifying preconfigured environment data associated with a customizable resource environment of the specific type based on receiving a resource environment creation request to generate a customized resource environment of a specific type in the cloud computing system.

In various implementations, act 710 includes providing a virtualization operation center user interface that includes a selectable element to generate a customized resource environment creation request that, when selected, automatically initiates the creation of the customized resource environment. In some instances, the customized resource environment includes networking resources, virtual machine configurations, virtual machine management functions, data accounts, monitoring functions, and cloud virtual desktops having the one or more virtual machines. In some instances, the customized resource environment includes cloud resources for networking, virtual machine configurations, virtual machine management, storage accounts, and a cloud virtual desktop having the one or more virtual machines. In some instances, a first customized resource environment of a first type corresponds to a first customizable resource environment, a second customized resource environment of a second type corresponds to a second customizable resource environment, and the first customizable resource environment differs from the second customizable resource environment.

As further shown, the first series of acts 700 includes act 720 of receiving configuration inputs for the customizable resource environment. For instance, in example implementations, act 720 involves receiving a set of configuration inputs for the customizable resource environment of the specific type. In various implementations, the set of configuration inputs includes a customized resource environment name, a virtual machine version, an operating system version, a network type, and a region identity. In some instances, the set of configuration inputs includes a virtual machine count.

As further shown, the first series of acts 700 includes act 730 of creating a cloud resource group for data resources indicated in preconfigured environment data. For instance, in example implementations, act 730 involves creating a cloud resource group within the cloud computing system to be a cloud resource container for data resources indicated in the preconfigured environment data. In some implementations, act 730 includes generating a customized resource environment by creating a cloud resource group within the cloud computing system to be or serve as a cloud resource container for data resources indicated in the preconfigured environment data of a specific type.

In one or more implementations, act 730 includes initializing the cloud resource group with role-based access control security policies. In various implementations, act 730 includes initializing the cloud resource group with role-based access control security policies.

In various implementations, act 730 may include determining necessary permissions for the cloud resource group to create component resources and initializing the cloud resource group with system-level role-based access control security policies based on the necessary permissions. In some instances, act 730 may include creating a network stack for the cloud resource group. In one or more implementations, creating the network stack for the cloud resource group includes setting up a virtual network, a subnet, and a network security group.

As further shown, the first series of acts 700 includes act 740 of generating configuration functions for the data resources. For instance, in example implementations, act 740 involves generating configuration functions for the data resources based on the set of configuration inputs. In some implementations, act 740 includes generating configuration functions for the data resources based on a set of configuration inputs received in connection with a resource environment creation request to generate a customized resource environment of the specific type in the cloud computing system.

In various implementations, act 740 includes configuring the role-based access control roles for the data resources by assigning corresponding minimal role permissions to the data resources to reduce security risks. In various implementations, the data resources are created using asynchronous calls to generate one or more components within the cloud resource group.

In some instances, the data resources include a storage account, profile storage, a monitoring function, an application configuration, an analytics log, a data collection mechanism, a service bus, and a key vault. In one or more implementations, configuring the role-based access control roles for the data resources includes assigning corresponding role-based access control roles to the storage account, the profile storage, the monitoring function, the application configuration, the analytics log, the data collection mechanism, the service bus, and the key vault. In some instances, the data resources include a host pool of the one or more virtual machines to host user sessions and an application group that includes applications to which users will have access.

As further shown, the first series of acts 700 includes act 750 of configuring role-based access control roles. For instance, in example implementations, act 750 involves configuring role-based access control roles for the data resources.

As further shown, the first series of acts 700 includes act 760 of provisioning virtual machines based on the configuration functions to generate the customized resource environment. For instance, in example implementations, act 760 involves provisioning one or more virtual machines within the cloud resource group based on the configuration functions and the set of configuration inputs to generate the customized resource environment. In some implementations, act 760 includes finalizing the setup of the one or more virtual machines by applying detailed configuration settings, installing software, implementing security policies, and performing validation checks to ensure that the one or more virtual machines are fully operational.

In various implementations, provisioning the one or more virtual machines within the cloud resource group includes loading created components with component-specific values included in the configuration functions for the components and connecting the components to network resources of the customized resource environment. In one or more implementations, one or more of the component-specific values are based on the set of configuration inputs.

In various implementations, act 760 includes finalizing the setup of the one or more virtual machines by applying detailed configuration settings, installing software, implementing security policies, and performing validation checks to ensure that the one or more virtual machines are fully operational. In various implementations, the virtualization operation center user interface includes an additional selectable element to automatically update the data resources of the customized resource environment.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 stored in the memory 803. Any of the various examples of modules and components described herein may be implemented, partially or wholly, as instructions 805 stored in memory 803 and executed by the processor 801. Any of the various examples of data described herein may be among the data 807 stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided to convert data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

This disclosure describes a subjective data application system within the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry the required program code in the form of computer-executable instructions or data structures, which can be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or another data link that enables the transportation of electronic data between respective client devices and components (e.g., server devices and/or virtual machines thereon) of the cloud computing system.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Furthermore, upon reaching various computer system components, program code means in the form of computer-executable instructions or data structures can be automatically transferred from transmission media to non-transitory computer-readable storage media (devices), or vice versa. For example, computer-executable instructions or data structures received over a network or data link can be buffered in random-access memory (RAM) within a network interface module (NIC) and then eventually transferred to computer system RAM and/or to less volatile computer storage media (devices) at a computer system. Thus, it should be understood that computer-readable storage media (devices) can be included in computer system components that also (or even primarily) utilize transmission media.

The disclosure may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available medium that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage, or other magnetic storage devices, or any other medium that can be used to store desired program code means in the form of computer-executable instructions or data structures and that can be accessed by a general-purpose or special-purpose computer.

The steps and/or actions of the methods described herein may be interchanged with one another without departing from the scope of the claims. In other words, unless a specific order of steps or actions is required for the proper operation of the method being described, the order and/or use of specific steps and/or actions may be modified without departing from the scope of the claims.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for creating one or more customized resource environments in a cloud computing system, comprising:
based on receiving a resource environment creation request to generate a customized resource environment of a specific type in the cloud computing system, identifying preconfigured environment data associated with a customizable resource environment of the specific type;
receiving a set of configuration inputs for the customizable resource environment of the specific type;
creating a cloud resource group within the cloud computing system to be a cloud resource container for data resources indicated in the preconfigured environment data ;
generating configuration functions for the data resources based on the set of configuration inputs;
configuring role-based access control roles for the data resources; and
provisioning one or more virtual machines within the cloud resource group based on the configuration functions and the set of configuration inputs to generate the customized resource environment.

2. The computer-implemented method of claim 1, wherein the customized resource environment includes cloud resources for networking, virtual machine configurations, virtual machine management, storage accounts, and a cloud virtual desktop having the one or more virtual machines.

3. The computer-implemented method of claim 1, wherein the set of configuration inputs includes a customized resource environment name, a virtual machine version, an operating system version, a network type, and a region identity.

4. The computer-implemented method of claim 3, wherein the set of configuration inputs includes a virtual machine count.

5. The computer-implemented method of claim 1, further comprising:
determining necessary permissions for the cloud resource group to create component resources; and
initializing the cloud resource group with system-level role-based access control security policies based on the necessary permissions.

6. The computer-implemented method of claim 1, further comprising creating a network stack for the cloud resource group.

7. The computer-implemented method of claim 6, wherein creating the network stack for the cloud resource group includes setting up a virtual network, a subnet, and a network security group.

8. The computer-implemented method of claim 1, wherein configuring the role-based access control roles for the data resources includes assigning corresponding minimal role permissions to the data resources to reduce security risks.

9. The computer-implemented method of claim 1, wherein the data resources include a storage account, profile storage, a monitoring function, an application configuration, an analytics log, a data collection mechanism, a service bus, and a key vault.

10. The computer-implemented method of claim 9, wherein the data resources are created using asynchronous calls to generate one or more components within the cloud resource group.

11. The computer-implemented method of claim 9, wherein configuring the role-based access control roles for the data resources includes assigned corresponding role-based access control roles to the storage account, the profile storage, the monitoring function, the application configuration, the analytics log, the data collection mechanism, the service bus, and the key vault.

12. The computer-implemented method of claim 11, wherein the data resources include:
a host pool of the one or more virtual machines to host user sessions; and
an application group that includes applications to which users will have access.

13. The computer-implemented method of claim 1, wherein provisioning the one or more virtual machines within the cloud resource group includes:
loading created components with component-specific values included in the configuration functions for the created components, and wherein one or more of the component-specific values are based on the set of configuration inputs; and
connecting the created components to network resources of the customized resource environment.

14. The computer-implemented method of claim 1, wherein:
a first customized resource environment of a first type corresponds to a first customizable resource environment;
a second customized resource environment of a second type corresponds to a second customizable resource environment; and
the first customizable resource environment differs from the second customizable resource environment.

15. The computer-implemented method of claim 1, further comprising finalizing setup of the one or more virtual machines by applying detailed configuration settings, installing software, implementing security policies, and performing validation checks to ensure the one or more virtual machines are fully operational.

16. A system for creating one or more customized resource environments in a cloud computing system, the system comprising:
a processing system having a processor; and
a computer memory including instructions that, when executed by the processing system, cause the system to carry out operations comprising:
generating a customized resource environment by creating a cloud resource group within the cloud computing system to be a cloud resource container for data resources indicated in preconfigured environment data of a specific type;
generating configuration functions for the data resources based on a set of configuration inputs received in connection with a resource environment creation request to generate a customized resource environment of the specific type in the cloud computing system;
configuring role-based access control roles for the data resources; and
provisioning one or more virtual machines within the cloud resource group based on the configuration functions and the set of configuration inputs to generate the customized resource environment.

17. The system of claim 16, further comprising providing a virtualization operation center user interface that includes a selectable element to generate a customized resource environment creation request that, when selected, automatically initiates creation of the customized resource environment.

18. The system of claim 17, wherein the virtualization operation center user interface includes an additional selectable element to automatically update the data resources of the customized resource environment.

19. A non-transitory computer-readable storage medium comprising instructions that, when executed by a processor, cause a computer device to carry out operations comprising:
based on receiving a resource environment creation request to generate a customized resource environment of a specific type in a cloud computing system, identifying preconfigured environment data associated with a customizable resource environment of the specific type;
receiving a set of configuration inputs for the customizable resource environment of the specific type, including a customized resource environment name, a virtual machine version, an operating system version, a network type, and a region identity;
creating a cloud resource group within the cloud computing system to be a cloud resource container for data resources indicated in the preconfigured environment data ;
initializing the cloud resource group with role-based access control security policies;
creating a network stack for the cloud resource group;
generating configuration functions for the data resources based on the set of configuration inputs;
configuring role-based access control roles for the data resources;
provisioning one or more virtual machines within the cloud resource group based on the configuration functions and the set of configuration inputs; and
finalizing setup of the one or more virtual machines by applying detailed configuration settings, installing software, implementing security policies, and performing validation checks to ensure the one or more virtual machines are fully operational.

20. The non-transitory computer-readable storage medium of claim 19, wherein the data resources include a storage account, profile storage, a monitoring function, an application configuration, an analytics log, a data collection mechanism, a service bus, a key vault, a host pool of the one or more virtual machines, and an application group.
